(19) United States
(12) Patent Application Publication
(10) Pub. No.: US 2016/0255592 A1
(43) Pub. Date: Sep. 1, 2016

(54) COMMUNICATION DEVICE AND METHOD FOR CONTROLLING POWER THEREOF

(71) Applicant: SOLID, INC., Gyeonggi-do (KR)

(72) Inventor: Hwan Sun LEE, Gyeonggi-do (KR)

(21) Appl. No.: 14/714,538

(22) Filed: May 18, 2015

Related U.S. Application Data
(63) Continuation of application No. PCT/KR2015/001863, filed on Feb. 26, 2015.

(51) Int. Cl. H04W 52/28; H04W 72/04

(52) U.S. Cl. CPC H04W 52/28; H04W 72/042

(57) ABSTRACT

A communication device for power saving and a method for controlling power thereof are provided. The communication device includes: a power amplifying unit configured to generate an output signal obtained by amplifying a downlink signal, using a supply voltage, and output the output signal; and a control unit configured to determine a current state by comparing predetermined downlink reference information with output signal information on the output signal, and, if the current state is an idle state as a comparison result, control the supply voltage to correspond to a first voltage. Accordingly, power for amplifying a signal can be controlled according to communication traffic, thereby preventing consumption of unnecessary power.

### CROSS-REFERENCE TO RELATED APPLICATIONS

The present application is a continuation application to International Application No. PCT/KR2015/001863, with an International Filing Date of Feb. 26, 2015, the entire contents of which are incorporated herein by reference.

### BACKGROUND

The inventive concept relates to a communication device and a method for controlling power thereof, and more particularly, to a communication device which is capable of efficiently decreasing power consumption, and a method for controlling power thereof.

With the development of information and communication technologies, changes in living patterns, and high economic growth, the pattern of communication culture is rapidly changed. In a technetronic society, a mobile communication terminal capable of receiving a wireless communication service anytime and anywhere according to needs for information transfer at high speed becomes one of important communication devices indispensable to daily life.

Unlike wide area systems using a communication service area as one wide area, most communication systems for communication services of mobile communication terminals provide communication services by dividing a service area into small areas called “cells.” A communication device, such as a repeater, which provides smooth communication services between base stations and mobile communication terminals, is installed in a radio wave shadow area, such as a basement, an interior of a building or a tunnel, which radio waves are difficult to reach. The communication device receives and amplifies a low-power signal transmitted from a base station and then transmits the signal to a mobile communication terminal or another communication device in a radio wave shadow area. Also, the communication device amplifies and filters a signal of the mobile communication terminal located in the radio wave shadow area so that the signal can reach the base station, and transmits the signal to the base station.

The communication device receives power supplied from a power supply unit (PSU) for the purpose of its stable operation, and amplifies and outputs a received signal by using the supplied power. In this instance, the communication device always amplifies the received signal by using constant power regardless of the magnitude of the signal. Hence, when the magnitude of the received signal is small, the communication device consumes relatively excessive power. That is, when a received signal is relayed, the conventional communication device always transmits/receives the signal by using constant power. Therefore, the constant power is supplied even in an idle state, which results in consumption of unnecessary power.

An embodiment of the inventive concept is directed to a communication device and a method for controlling power thereof, which can control power for amplifying a received signal according to the magnitude of the signal.

### SUMMARY

According to an aspect of the inventive concept, there is provided a communication device, comprising: a power amplifying unit configured to generate an output signal obtained by amplifying a downlink signal, using a supply voltage, and output the output signal; and a control unit configured to determine a current state by comparing predetermined downlink reference information with output signal information on the output signal, and, if the current state is an idle state as a comparison result, control the supply voltage to correspond to a first voltage.

The communication device may further comprise a storage unit configured to store first idle time information. If the current state is the idle state and a current time corresponds to the first idle time information, the control unit may control the supply voltage to correspond to a second voltage.

The second voltage may be a voltage lower than the first voltage.

If the idle state is released at a time corresponding to the first idle time information, the control unit may delete the first idle time information.

The communication device further comprises a storage unit configured to store second idle time information. The control unit may generate the second idle time information corresponding to a time when the current state is determined as the idle state.

If the time when the current state is determined as the idle state is repeated m times, the control unit may generate the second idle time information. The m may be a natural number of 2 or more.

If it is determined that the current state has been released from the idle state, the control unit may control the supply voltage to correspond to a normal voltage.

The first voltage may be a voltage lower than the normal voltage.

The output signal information may correspond to any one of an average value and a root mean square with respect to power of the output signal.

The power amplifying unit may comprise a plurality of power amplifiers configured to perform different communication services, and the control unit may control the power input to each of the plurality of power amplifiers.

The control unit may determine the current state by comparing predetermined uplink reference information with uplink signal information on an uplink signal.

According to other aspect of the inventive concept, there is provided a method for controlling power of a communication device, the method comprising: comparing predetermined downlink reference information with output signal information on an output signal obtained by amplifying a downlink signal using a supply voltage; determining whether a current state of the device is an idle state based on a comparison result; and if it is determined that the current state of the device is the idle state, controlling the supply voltage.

The controlling of the supply voltage may comprise, if the current state is the idle state, determining whether a current time corresponds to first idle time information; and if the current time does not correspond to the first idle time information, controlling the supply voltage to correspond to a first voltage.

The controlling of the supply voltage may further comprise, if the current time corresponds to the first idle time information, controlling the supply voltage to correspond to a second voltage.

The method may further comprise, if the idle state is released at a time corresponding to the first idle time information, deleting the first idle time information.

The method may further comprise, generating second idle time information corresponding to a time when the current state is determined as the idle state.

The generating of the second idle time information may comprise, if the time when the current state is determined as the idle state is repeated m times, generating the second idle time information. The m may be a natural number of 2 or more.

The method may further comprise, if it is determined that the current state has been released from the idle state, controlling the supply voltage to correspond to a normal voltage.

According to another aspect of the inventive concept, there is provided a method for controlling power of a communication device, the method comprising: comparing predetermined uplink reference information with uplink signal information on an uplink signal; and determining whether the current state of the device is the idle state based on a comparison result; if it is determined that the current state of the device is the idle state, controlling a supply voltage for amplifying a downlink signal.

### BRIEF DESCRIPTION OF THE DRAWINGS

The above and other features of the inventive concept will now be described in detail with reference to certain exemplary embodiments thereof illustrated the accompanying drawings which are given hereinbelow by way of illustration only, and thus are not limitative of the inventive concept, and wherein:

FIG. 1 is a configuration diagram of a mobile communication system according to an embodiment of the inventive concept;

FIG. 2 is a block configuration diagram of a communication device according to an embodiment of the inventive concept;

FIG. 3 is a graph illustrating outputs with respect to inputs of a power amplifying unit provided in the communication device according to the embodiment of the inventive concept;

FIG. 4 is a block configuration diagram of a communication device according to another embodiment of the inventive concept; and

FIG. 5 is a flowchart illustrating a method for controlling power of a communication device according to an embodiment of the inventive concept.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein.

Rather, these embodiments are provided so that this disclosure will be thorough and complete, and will fully convey the scope of the inventive concept to those skilled in the art. Throughout the disclosure, like reference numerals refer to like parts throughout the various figures and embodiments of the inventive concept.

When referring to “connected” or “coupled” for one component to another, though it is possible for one component to be connected or coupled directly to another, it is also understood that there may be a third component therebetween. However, when referring to “directly connected” or “directly coupled” for one component to another, it is understood that there is no other component therebetween.

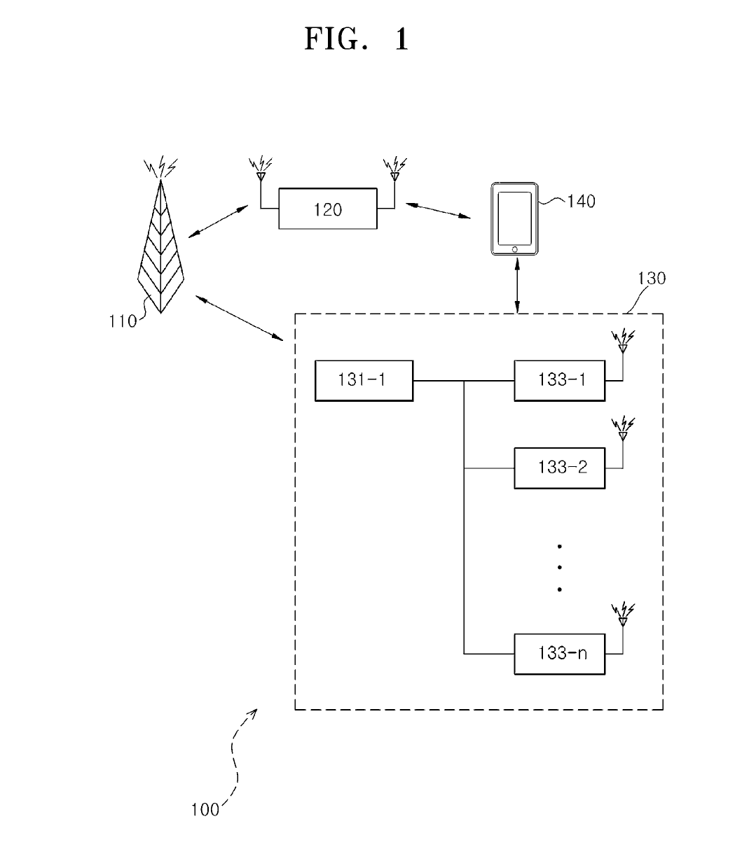

FIG. 1 is a configuration diagram of a mobile communication system according to an embodiment of the inventive concept.

Referring to FIG. 1, the mobile communication system 100 according to the embodiment of the inventive concept includes a base station 110, a first communication device 120, a second communication device 130 and a mobile communication terminal 140. Here, the first communication device 120 is exemplified as a repeater. The second communication device 130 is exemplified as at least one node unit of distributed antenna system (DAS). Thus, the second communication device 130 may be a master unit 131-1 connected by wire to a base station, and/or at least one of n remote units 133-1, 133-2, . . . , 133-n (hereinafter, commonly designated as 133-n) connected by wire to the master unit 131-1.

Here, the base station 110 is a wireless communication device for connecting terminals to a network in order to provide wireless communication services. The base station 110 connects terminals to an access network such as long term evolution (LTE), code division multiple access (CDMA), wireless broadband Internet (WiBro), wideband code division multiple access (WCDMA), or global system for mobile communications (GSM). In addition, the base station 110 communicates with the mobile communication terminal 140 or the first or second communication device 120 or 130 through communication such as wired local loop (WLL), wireless LAN (Wi-Fi), world interoperability for microwave access (WiMAX), or wide area networks (WAN). That is, the base station 110 connects the mobile communication terminal 140 to a mobile communication network in order to provide mobile communication services.

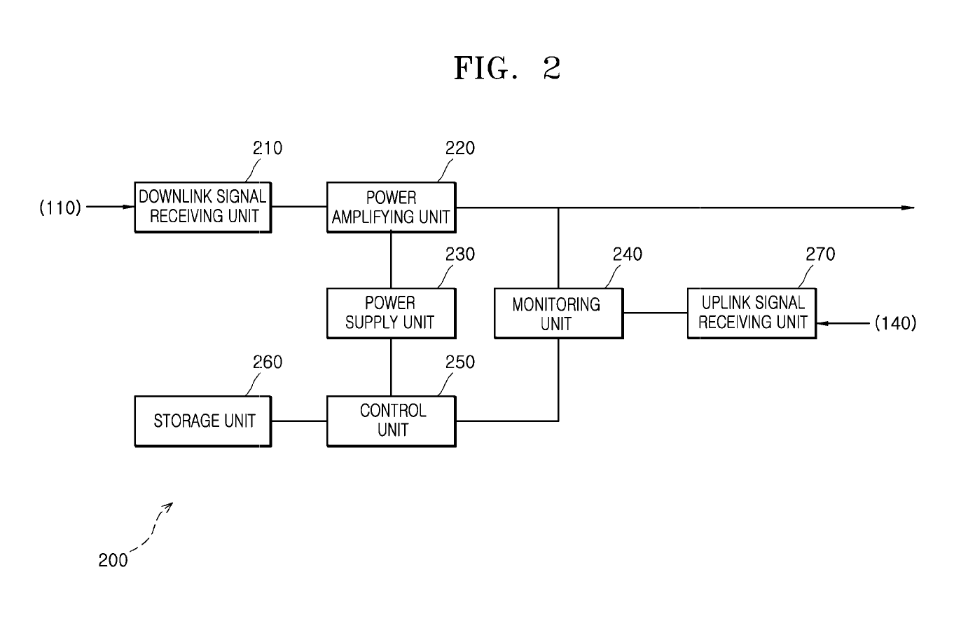

In a case where it is difficult to perform smooth signal transmission due to a long distance between the base station 110 and the mobile communication terminal 140, the first or second communication device 120 or 130 may function to amplify signals between the base station 110 and the mobile communication terminal 140. In this instance, the first or second communication device 120 or 130 according to the embodiment of the inventive concept may monitor a signal input from the base station 110 and/or another communication device (not shown) (hereinafter, referred to as a ‘downlink signal’) in order to prevent consumption of unnecessary power. If the first or second communication device 120 or 130 is in an idle state in which the magnitude of the downlink signal is small as a monitoring result, the first or second communication device 120 or 130 according to the embodiment of the inventive concept may control power for amplifying the downlink signal. Hereinafter, an operation of the first or second communication device 120 or 130 according to the embodiment of the inventive concept will be described in detail with reference to FIG. 2.

FIG. 2 is a block configuration diagram of a communication device according to an embodiment of the inventive concept.

Referring to FIG. 2, the communication device 200 according to the embodiment of the inventive concept may include a downlink signal receiving unit 210, a power amplifying unit 220, a power supply unit 230, a monitoring unit 240, a control unit 250, a storage unit 260 and an uplink signal receiving unit 270. The communication device 200 according to the embodiment of the inventive concept has a concept including both the first communication device 120 and the second communication device 130. Thus, in the case of the second communication device 130 that is a node unit of DAS, the master unit 131-1 and/or the remote unit 133-n may include the components described above. Therefore, hereinafter, the first communication device 120 and the second communication device 130 will be commonly referred to as the communication device 200 without distinction.

If a downlink signal transmitted from the base station 110 and/or another communication device (not shown) is input to the downlink signal receiving unit 210, the downlink signal receiving unit 210 may output the input downlink signal to the power amplifying unit 220. The downlink signal may include data, communication scheme and power information. The downlink signal may further include time information and the like. The downlink signal receiving unit 210 may include an antenna and the like.

The uplink signal receiving unit 270 may receive an uplink signal from another communication device (not shown) and/or the mobile communication terminal 140. The received uplink signal may be processed to be transmitted to the base station 110. The uplink signal may include data, communication scheme and power information. The uplink signal may further include time information and the like. The uplink signal receiving unit 270 may include an antenna and the like.

The power amplifying unit 220 may amplify and output the downlink signal input from the downlink signal receiving unit 210 by using a supply voltage supplied from the power supply unit 230 (hereinafter, the signal amplified in the power amplifying unit 220 is referred to as an ‘output signal’). That is, the power amplifying unit 220 may include one or more power amplifiers. The power amplifier may amplify the downlink signal by using the supply voltage and then output the output signal. For example, it is assumed that the power amplifier includes at least one power transistor that receives a supply voltage supplied through a drain terminal from the power supply unit 230. In this instance, the power transistor included in the power amplifier may amplify a downlink signal by using the supply voltage supplied from the power supply unit 230.

The monitoring unit 240 may monitor an output signal output from the power amplifying unit 220, and output a monitoring result to the control unit 250. As an example, the monitoring unit 240 may monitor an output signal, thereby generating output signal information on the output signal. The output signal information is information on the power of an output signal, and may be information corresponding to an average value and/or a root mean square (RMS) with respect to power of the output signal. As another example, the monitoring unit 240 may reproduce an output signal and output the reproduced output signal to the control unit 250. In this case, the control unit 250 may generate output signal information on the input output signal.

The monitoring unit 240 may monitor an uplink signal received to the uplink signal receiving unit 270, and output a monitoring result to the control unit 250. As an example, the monitoring unit 240 may monitor an uplink signal, thereby generating uplink signal information on the uplink signal. The uplink signal information is information on the power of an uplink signal, and may be information corresponding to an average value and/or an RMS with respect to power of the uplink signal. As another example, the monitoring unit 240 may reproduce an uplink signal and output the reproduced uplink signal to the control unit 250. In this case, the control unit 250 may generate uplink signal information on the input uplink signal.

The control unit 250 may determine a current state based on the output signal information and/or the uplink signal information. As an example, the control unit 250 may determine a current state by comparing predetermined downlink reference information with the output signal information. That is, if the output signal information is not less than the downlink reference information, the control unit 250 may determine that the current state is a normal state. Here, the normal state is a state in which communication traffic is high, and may be a state in which communication is normally performed. This is because, if the output signal information is not less than the downlink reference information, the power of the output signal is high, which means that downlink communication traffic is high. On the contrary, if the output signal information is less than the downlink reference information, the control unit 250 may determine that the current state is an idle state. The idle state may be a state in which communication traffic is low or a communication standby state. This is because, if the output signal information is less than the downlink reference information, the power of the output signal is low, which means that the downlink communication traffic is low.

As another example, the control unit 250 may determine a current state by comparing predetermined uplink reference information with the uplink signal information. That is, if the uplink signal information is not less than the uplink reference information, the control unit 250 may determine that the current state is the normal state. This is because, if the uplink signal information is not less than the uplink reference information, the power of the uplink signal is high, which means that uplink communication traffic is high. On the contrary, if the uplink signal information is less than the uplink reference information, the control unit 250 may determine that the current state is the idle state. This is because, if the uplink signal information is less than the uplink reference information, the power of the uplink signal is low, which means that the uplink communication is low.

As still another example, if it is determined that both the downlink communication traffic and the uplink communication traffic are low, the control unit 250 may determine that the current state is the idle state. If it is determined that at least one of the downlink communication traffic and the uplink communication traffic is high, the control unit 250 may determine that the current state is the normal state. As still another example, if it is determined that any one of the downlink communication traffic and the uplink communication traffic is low, the control unit 250 may determine that the current state is the idle state. As described above, the control unit 250 may determine whether the current state is the normal state or the idle state by using the output signal information and/or the uplink signal information.

Thus, the control unit 250 may control a maximum voltage (hereinafter, referred to as a ‘normal voltage’) at which the power amplifying unit 220 can maintain linearity when the current state is the normal state to be supplied to the power amplifying unit 220. The control unit 250 may also control a first voltage lower than the normal voltage when the current state is the idle state to be supplied to the power amplifying unit 220.

Meanwhile, if it is determined that the current state is the idle state, the control unit 250 may determine whether a current time corresponds to idle time information. Here, the idle time information is information on a time when the idle state repeatedly occurs, and may be information previously stored in the storage unit 260. For example, it is assumed that the communication device 200 is installed inside a subway tunnel In the case of the subway, the subway is operated only for a fixed time period (e.g., from 05:00 AM to 11:30 PM) everyday. For a time period in which the subway is not operated, it is highly likely that the current state of the communication device 200 will be maintained as the idle state. Therefore, in a case where the current state is the idle state and the current time is an idle time, the control unit 250 may control a second voltage lower than the first voltage to be supplied to the power amplifying unit 220. Here, the first and second voltages are previously set voltages. The first voltage may be a voltage lower than the normal voltage, and the second voltage may be a voltage lower than the first voltage.

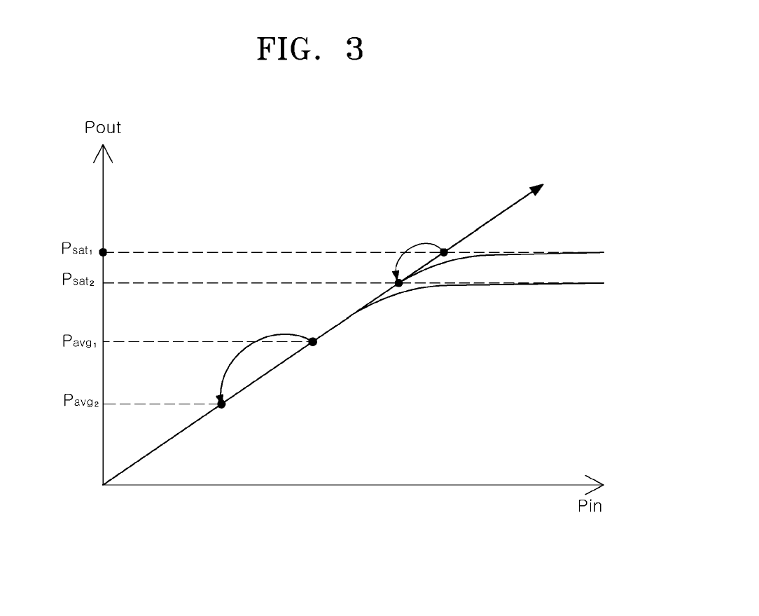

The power of the output signal is changed corresponding to not only the voltage supplied from the power supply unit 230 but also the input power of the downlink signal input through the downlink signal receiving unit 210. The change of the power of the output signal will be described referring to FIG. 3.

FIG. 3 is a graph illustrating outputs with respect to inputs of the power amplifying unit provided in the communication device according to the embodiment of the inventive concept.

The magnitude of power of an output signal may be changed by power of a downlink signal input to the power amplifying unit 220 and a voltage supplied to the power amplifying unit 220 from the power supply unit 230. The gain of the output signal may be the same regardless of the power of the downlink signal and the voltage supplied from the power supply unit 230. As shown in FIG. 3, it can be seen that if the power of the input downlink signal is high due to an increase in communication traffic, the communication device 200 outputs an output signal with high power, and if the power of the input downlink signal is low due to a decrease in communication traffic, the communication device 200 outputs an output signal with low power. Also, it can be seen that in a case where the power of the downlink signal input to the power amplifying unit 220 is constant, the power of an available output signal decreases as the voltage supplied to the power amplifying unit 220 from the power supply unit 230 is lowered.

Pavg1 is a value corresponding to the output signal information in the normal state. Pavg2 is a value corresponding to the output signal information in the idle state. As shown in FIG. 3, it can be seen that the value of the output signal information in the idle state decreases as compared that in the normal state.

Psat1 is linear output power that the power amplifier within the power amplifying unit 220 can maximally use in the normal state. Psat2 is linear output power that the power amplifier within the power amplifying unit 220 can maximally use in the idle state. As shown in FIG. 3, it can be seen that, since the first voltage (smaller than the normal voltage) is supplied to the power amplifier within the power amplifying unit 220 in the idle state, Psat1 is smaller than Psat2. That is, it can be seen that the power of an available output signal in the idle state decreases as compared with that in the normal state (Psat1>Psat2).

Although the power of an available output signal decreases as the voltage supplied to the power amplifying unit 220 is controlled as the first voltage, the back-off amount of the power amplifying unit 220 is sufficiently secured. Hence, the performance of the communication device 200 is not deteriorated. This is because the output signal information in the idle state also decreases (as compared with that in the normal state).

Although not shown in this figure, if the voltage supplied to the power amplifying unit 220 is controlled as the second voltage, the linear output power that the power amplifier within the power amplifying unit 220 can maximally use will become smaller than Psat2. In this case, the back-off amount of the power amplifying unit 220 may not be sufficiently secured, but it is hardly likely that the communication traffic will increase for the idle time. Thus, although the voltage supplied to the power amplifying unit 220 is controlled as the second voltage, it is hardly likely that the performance of the communication device 200 will be deteriorated.

The communication device 200 can decrease the supply voltage supplied to the power amplifying unit 220 in the idle state and/or the idle time by the operation described above. The power consumed in the communication device 200 is in proportion to the power (voltage) supplied to the power amplifying unit 220. Thus, the power consumed in the communication device 200 can be reduced.

Referring back to FIG. 2, the control unit 250 may determine whether the idle state is maintained by monitoring the output signal and/or the uplink signal. As described above, the monitoring unit 240 may monitor the output signal and/or the uplink signal, and output the monitoring result to the control unit 250. If it is determined that the current state has returned to the normal state as the monitoring result (i.e., if it is determined that the current state is released from the idle state), the control unit 250 may control the power supply unit 230 such that the normal voltage is supplied to the power amplifying unit 220.

If the idle state is released, the control unit 250 may generate information (i.e., idle time information) on a time for which the idle state is maintained, and store the generated information in the storage unit 260. For example, the control unit 250 may recognize a time when the current state is switched from the normal state to the idle state and a time when the current state is switched from the idle time to the normal state, and generate idle time information on the recognized times, thereby storing the generated idle time information in the storage unit 260. That is, it is assumed that the current state has been switched from the normal state to the idle state at 22:00 PM, and the current state has been again released from the idle state at 23:00 PM. Then, the control unit 250 may generate “22:00 PM to 23:00 PM” as idle time information, and store the generated idle time information in the storage unit 260.

In a case where the time when the current state is determined as the idle state is repeated preset m times or more, the control unit 250 may generate idle time information (here, the m is a natural number of 2 or more). For example, it is assumed that the m is previously set as 10. In a case where the idle time occurs at the same time for 10 days, the control unit 250 may generate information on the time as idle time information. This is because that the idle state is repeated at the same time for consecutive m days or more means that it is highly likely that the current state will become the idle state at the time.

Meanwhile, if it is determined that the current state is the normal state even though the time is a time corresponding to the idle time information, the control unit 250 may delete the idle time information. This is because that communication traffic is high at a time corresponding to the idle time information means that the time is no longer the idle time.

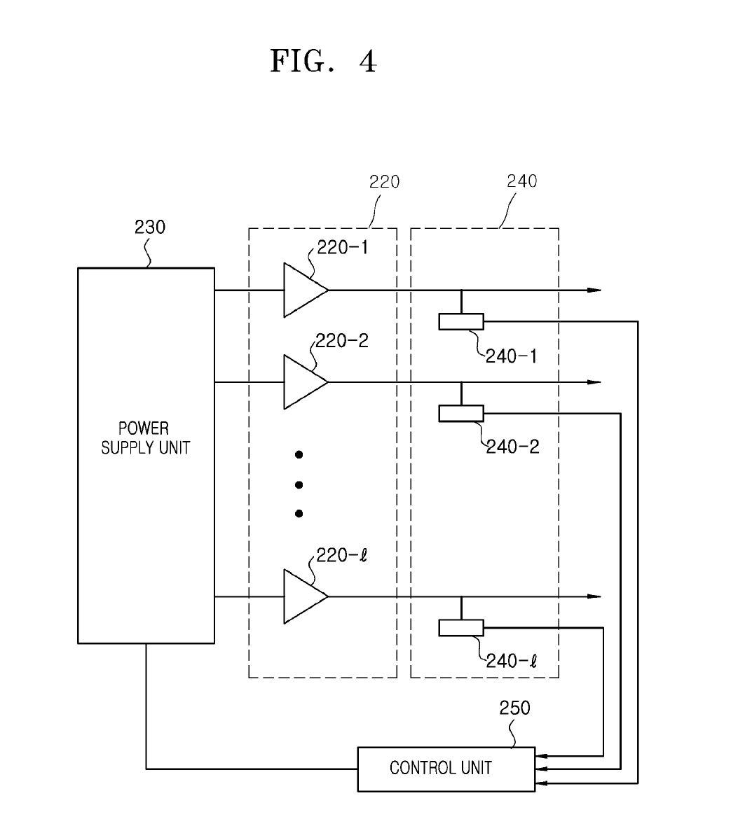

In the above, the case where one power amplifier is included in the power amplifying unit 220 has been assumed and described. Hereinafter, a case where a plurality of power amplifiers are included in the power amplifying unit 220 will be described with reference to FIG. 4.

FIG. 4 is a block configuration diagram of a communication device according to another embodiment of the inventive concept.

Referring to FIG. 4, a power amplifying unit 220 of the communication device 200 according to the embodiment of the inventive concept includes 1 power amplifiers 220-1, 220-2, . . . , 220-l, and a monitoring unit 240 of the communication device 200 includes 1 sub-monitoring units 240-1, 240-2, . . . , 240-l for monitoring output signals output from the respective power amplifiers. Meanwhile, in FIG. 4, it has been illustrated that, for convenience of illustration, the monitoring unit 240 includes sub-monitoring units corresponding to the number of power amplifiers. However, the inventive concept is not limited thereto, and the number of sub-monitoring units may be different from that of power amplifiers.

The plurality of power amplifiers 220-1, 220-2, . . . , 220-l may output signals of communication schemes corresponding to different services. For example, a first power amplifier 220-1 may amplify a downlink signal of a CDMA, a second power amplifier 220-2 may amplify a downlink signal of a W-CDMA scheme, and e-th power amplifier 220-l may amplify a downlink signal of an LTE scheme. Here, each of the power amplifiers 220-1, 220-2, . . . , 220-l may includes at least one power transistor (not shown) receiving a supply voltage supplied from the power supply unit 230 through a drain terminal thereof.

The sub-monitoring units 240-1, 240-2, . . . , 240-l may monitor output signals output from the corresponding power amplifiers 220-1, 220-2, . . . , 220-l, respectively, and output monitoring results to the control unit 250. The control unit 250 may determine current states of the plurality of power amplifiers 220-1, 220-2, . . . , 220-l based on the results monitored by the plurality of sub-monitoring units 240-1, 240-2, . . . , 240-l, and control power corresponding to the current state to be supplied to each of the power amplifiers 220-1, 220-2, . . . , 220-l. Specifically, the control unit 250 may control the power supply unit 230 such that the supply voltage supplied to the drain terminal of the power transistor of each of the plurality of power amplifiers 220-1, 220-2, . . . , 220-l corresponds to the current state. Here, downlink reference information for determining idle states of the plurality of power amplifiers 220-1, 220-2, . . . , 220-l may be set different from one another.

Although not shown in this figure, the sub-monitoring units 240-1, 240-2, . . . , 240-l may monitor corresponding uplink signals, respectively, and output monitoring results to the control unit 250. The control unit 250 may determine current states of the plurality of power amplifiers 220-1, 220-2, . . . , 220-l based on the results monitored by the plurality of sub-monitoring units 240-1, 240-2, . . . , 240-l, and control power corresponding to the current state to be supplied to each of the power amplifiers 220-1, 220-2, . . . , 220-l.

In this case, uplink reference information for determining idle states of the power amplifiers 220-1, 220-2, . . . , 220-l may be set different from one another.

For example, it is assumed that a first sub-monitoring unit 240-1 monitors an output signal and an uplink signal of the CDMA scheme, and a second sub-monitoring unit 240-2 monitors an output signal and an uplink signal of the W-CDMA scheme. In this instance, the first sub-monitoring unit 240-1 may monitor an output signal and an uplink signal of the CDMA scheme and output the output signal and the uplink signal to the control unit 250. The second sub-monitoring unit 240-2 may monitor an output signal and an uplink signal of the W-CDMA scheme and output the output signal and the uplink signal to the control unit 250. The control unit 250 may analyze information received from each of the sub-monitoring units 240-1 and 240-2. As an analysis result, if the information received from the first sub-monitoring unit 240-1 is in the idle state, the control unit 250 may control a supply voltage supplied to the first power amplifier 220-1 to become a first voltage (or second voltage). On the other hand, if the information received from the second sub-monitoring unit 240-2 is in the normal state, the control unit 250 may control a supply voltage supplied to the second power amplifier 220-2 to become a normal voltage.

As described above, the communication device 200 according to the embodiment of the inventive concept can control power for amplifying a signal according to communication traffic, thereby preventing consumption of unnecessary power.

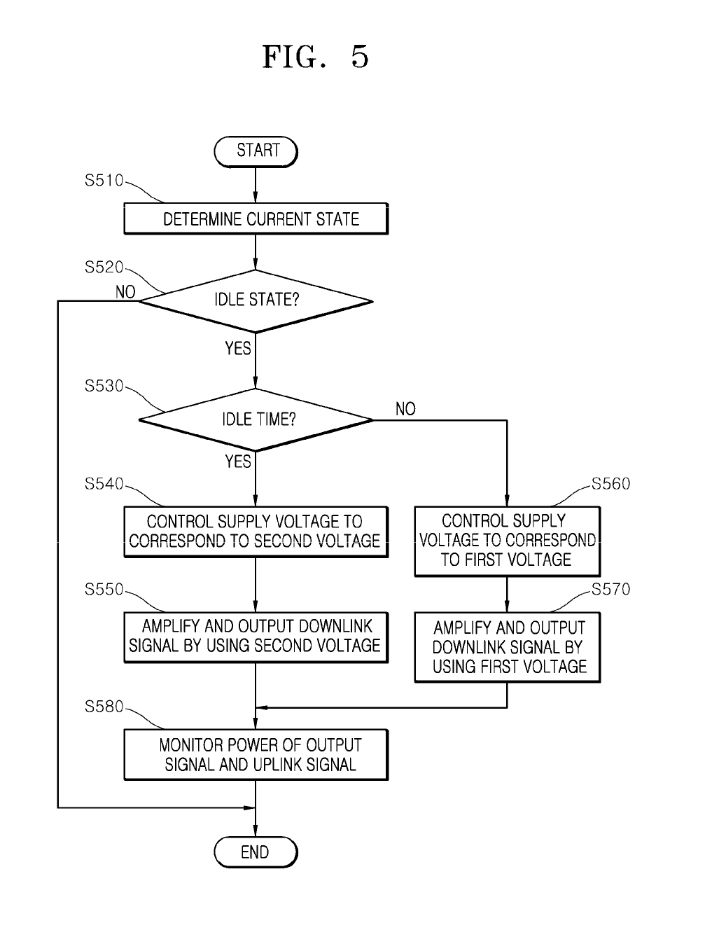

FIG. 5 is a flowchart illustrating a method for controlling power of a communication device according to an embodiment of the inventive concept.

Hereinafter, a method for controlling power of a communication device according to an embodiment of the inventive concept will be described with reference to FIG. 5. The following steps may be steps performed by the components included in the communication device 200 described with reference to FIG. 2, but will be commonly referred to as steps performed in the communication device 200 for convenience of understanding and explanation. Therefore, a subject performing each of the following steps may be omitted.

In step S510, the communication device 200 determines a current state according to a predetermined method. The communication device 200 may amplify a downlink signal received from the base station 110 and/or another communication device (not shown) by using a predetermined supply voltage. The communication device 200 may determine the current state by comparing predetermined downlink reference information with output signal information on an output signal. If the output signal information is not less than the downlink reference information, the communication device 200 may determine that the current state is a normal state. On the contrary, if the output signal information is less than the downlink reference information, the communication device 200 may determine that the current state is an idle state.

The communication device 200 may determine the current state by comparing predetermined uplink reference information with uplink signal information on an uplink signal. If the uplink signal information is not less than the uplink reference information, the communication device 200 may determine that the current state is the normal state. On the contrary, if the uplink signal information is less than the uplink reference information, the communication device 200 may determine that the current state is the idle state. The communication device 200 may determine that the current state is the idle state only when the output signal information is less than the downlink reference information, and the uplink signal information is less than the uplink reference information.

If it is determined that the current state is the idle state in step S520, i.e., if the output signal information is less than the downlink reference information, the communication device 200 determines whether a current time corresponds to idle time information (step S530). The idle time information is information on a time when the idle state repeatedly occurs, and may be information previously stored in a data storage space provided in the communication device 200.

In step S540, in a case where the current state is the idle state and the current time is an idle time, the communication device 200 amplifies the downlink signal by using a supply voltage corresponding to a second voltage. That is, in the case where the current state is the idle state and the current time is the idle time, the communication device 200 may control the supply voltage supplied to a power amplifier to correspond to the second voltage in order to amplify the downlink signal.

In step S550, the communication device 200 amplifies and outputs the downlink signal by using the second voltage.

In step 560, in a case where the current state is the idle state and the current time is not the idle time as a determination result in step S530, the communication device 200 amplifies the downlink signal by using a supply voltage corresponding to a first voltage. That is, in the case where the current state is the idle state and the current time is not the idle time, the communication device 200 may control the supply voltage supplied to the power amplifier to correspond to the first voltage in order to amplify the downlink signal.

In step S570, the communication device 200 amplifies and outputs the downlink signal by using the first voltage.

In step S580, the communication device 200 monitors the power of the amplified output signal and/or the uplink signal. If it is determined that the current state has been released from the idle state by monitoring the power of the amplified output signal and/or the uplink signal, the communication device 200 amplifies the downlink signal by using a supply voltage corresponding to a normal voltage. That is, in a case where the current state becomes the normal state as it is released from the idle state, the communication device 200 may control the power supplied to the power amplifier to correspond to the normal voltage in order to amplify the downlink signal.

Although not shown in this figure, the following steps may be further performed in step S580. That is, the communication device 200 may perform a step of, if the idle state is released, generating information (i.e., idle time information) on a time for which the idle state is maintained and storing the generated information in a storage space provided in the communication device 200. For example, the communication device 200 may recognize a time when the current state is switched from the normal state to the idle state and a time when the current state is switched from the idle time to the normal state, and generate idle time information on the recognized times, thereby storing the generated idle time information in the storage space.

Also, the communication device 200 may perform a step of, in a case where the time when the current state is determined as the idle state is repeated predetermined m times or more, generating idle time information (here, the m is a natural number of 2 or more). For example, it is assumed that the m is previously set as 10. In a case where the idle time occurs at the same time for 10 days, the communication device 200 may generate information on the time as idle time information. This is because that the idle state is repeated at the same time for consecutive m days or more means that it is highly likely that the current state will become the idle state at the time.

Also, the communication device 200 may perform a step of, if it is determined that the current state is the normal state even though the time is a time corresponding to the idle time information, deleting the idle time information. This is because that communication traffic is high at a time corresponding to the idle time information means that the time is no longer the idle time.

As described above, in the method according to the embodiment of the inventive concept, power for amplifying a signal can be controlled according to communication traffic, thereby preventing consumption of unnecessary power.

The method according to the inventive concept may be implemented as computer-readable codes on a computer-readable recording medium. The computer readable recording medium includes all kinds of recording media in which data that can be read by a computer system is stored. Examples of the computer readable recording media may be a read only memory (ROM), a random access memory (RAM), a magnetic tape, a magnetic disk, a flash memory, an optical data storage device, and the like. Also, the computer-readable recording medium may be distributed over computer systems connected to a computer communication network, and computer-readable codes distributively stored and executed therein.

While the inventive concept has been described with respect to the specific embodiments, it will be apparent to those skilled in the art that various changes and modifications may be made without departing from the spirit and scope of the invention as defined in the following claims.

What is claimed is:

1. A communication device, comprising:
a power amplifying unit configured to generate an output signal obtained by amplifying a downlink signal, using a supply voltage, and output the output signal; and
a control unit configured to determine a current state by comparing predetermined downlink reference information with output signal information on the output signal, and, if the current state is an idle state as a comparison result, control the supply voltage to correspond to a first voltage.

2. The communication device of claim 1, further comprising a storage unit configured to store predetermined first idle time information,
wherein, if the current state is the idle state and a current time corresponds to the first idle time information, the control unit controls the supply voltage to correspond to a second voltage.

3. The communication device of claim 2, wherein the second voltage is a voltage lower than the first voltage.

4. The communication device of claim 2, wherein, if the idle state is released at a time corresponding to the first idle time information, the control unit deletes the first idle time information.

5. The communication device of claim 1, further comprising a storage unit configured to store second idle time information,
wherein the control unit generates the second idle time information corresponding to a time when the current state is determined as the idle state.

6. The communication device of claim 5, wherein, if the time when the current state is determined as the idle state is repeated m times, the control unit generates the second idle time information,
wherein the m is a natural number of 2 or more.

7. The communication device of claim 1, wherein, if it is determined that the current state has been released from the idle state, the control unit controls the supply voltage to correspond to a normal voltage.

8. The communication device of claim 7, wherein the first voltage is a voltage lower than the normal voltage.

9. The communication device of claim 1, wherein the output signal information corresponds to any one of an average value and a root mean square with respect to power of the output signal.

10. The communication device of claim 1, wherein the power amplifying unit comprises a plurality of power amplifiers configured to perform different communication services, and the control unit controls the power input to each of the plurality of power amplifiers.

11. The communication device of claim 1, wherein the control unit determines the current state by comparing predetermined uplink reference information with uplink signal information on an uplink signal.

12. A method for controlling power of a communication device, the method comprising:
comparing predetermined downlink reference information with output signal information on an output signal obtained by amplifying a downlink signal using a supply voltage;
determining whether a current state of the device is an idle state based on a comparison result; and
if it is determined that the current state of the device is the idle state, controlling the supply voltage.

13. The method of claim 12, wherein the controlling of the supply voltage comprises:
if the current state is the idle state, determining whether a current time corresponds to first idle time information; and
if the current time does not correspond to the first idle time information, controlling the supply voltage to correspond to a first voltage.

14. The method of claim 13, wherein the controlling of the supply voltage further comprises, if the current time corresponds to the first idle time information, controlling the supply voltage to correspond to a second voltage.

15. The method of claim 13, further comprising, if the idle state is released at a time corresponding to the first idle time information, deleting the first idle time information.

16. The method of claim 12, further comprising generating second idle time information corresponding to a time when the current state is determined as the idle state.

17. The method of claim 16, wherein the generating of the second idle time information comprises, if the time when the current state is determined as the idle state is repeated m times, generating the second idle time information,
wherein the m is a natural number of 2 or more.

18. The method of claim 12, further comprising, if it is determined that the current state has been released from the idle state, controlling the supply voltage to correspond to a normal voltage.

19. A method for controlling power of a communication device, the method comprising:
comparing predetermined uplink reference information with uplink signal information on an uplink signal; and
determining whether the current state of the device is the idle state based on a comparison result;
if it is determined that the current state of the device is the idle state, controlling a supply voltage for amplifying a downlink signal.
